(19) United States
(12) Patent Application Publication
(10) Pub. No.: US 2018/0192675 A1
(43) Pub. Date: Jul. 12, 2018

(54) Apparatus for Food Degreasing/Warming

(71) Applicant: Anthony Blankenship, Fort Wayne, IN (US)

(72) Inventor: Anthony Blankenship, Fort Wayne, IN (US)

(21) Appl. No.: 15/401,057

(22) Filed: Jan. 8, 2017

(51) Int. Cl. A23L 5/20

(52) U.S. Cl. CPC A23L 5/27; A23V 2002/00

(57) ABSTRACT

The invention consists of an apparatus for fried food degreasing and warming. It is designed to enable a user to transfer from a cooking source fried food, typically consisting of food products such as fried meats, breads, vegetables and the like, to an apparatus that has a top lid and bottom lid affixed to each other in what is commonly known as a “clam shell” configuration. Attached inside of the top lid of the apparatus, via clips, is a specialized absorbent pad that has been designed such that fats and cooking oils are efficiently removed from the fried food. Additionally, the specialized absorbent pad can be manufactured in various sizes and dimensions to accommodate varying dimensions and quantities of fried food products. The configuration of the top lid and bottom lid makes it very easy for the user to remove and install a replacement specialized absorbent pad form the top lid once it becomes too saturated with fats and cooking oils to effectively absorb any additional fats and cooking oils from the fried foods. The bottom lid of the apparatus utilizes a rack and another absorbent pad, maintained in position by clips, that additionally provides further surface contact between the fried food and the specialized absorbent pad so that more fats and cooking oils can be removed from the fried food. Additionally, this particular rack has the capability of being oscillated by a vibrator means located in the interior of the bottom lid. The oscillation motion forces the fried food to make further contact with the surface area of the specialized absorbent pad, which has been designed with a particular fringe, fringe shape, and configuration to maximize contact between it and the fried food. This particular design maximizes the transfer of fats and cooking oils from the fried food to the specialized absorbent pad. Also, located in the bottom lid a heater unit that keeps the interior of the apparatus maintained a desirable temperature selected by the user. The addition of a heating source allows the fats and cooking oils to be maintained at higher than room temperature range, which also allows more fats and cooking oils to be absorbed and removed and also keeps the fried food at a more desirable temperature for consuming. Additionally, the present invention, in an alternative embodiment, has a means for it to be attached to the top of the range, or stove, being used by the user to fry the fried food. This positions the apparatus right at the “point of use” and makes the entire cooking/degreasing process safer and makes for less cleanup by the user.

Additionally, the present invention utilizes battery power to provide power to the heating source and vibrator means, which allows the present invention to be truly portable and not reliant upon a traditional AC source thus allowing the present invention to be used at picnics, campouts, etc.

### CROSS-REFERENCE TO RELATED APPLICATIONS

This is a non-provisional utility patent application bearing the title “Apparatus for Food Degreasing/Warming” filed on Jan. 7, 2017, the disclosure of which is incorporated, in its entirety, by this reference.

### BACKGROUND OF THE INVENTION

### 1. Field of the Invention

The present invention relates to an apparatus utilized by the user to remove fats and cooking oils commonly found on and contained in, fried food products, that are to be consumed by the user and to keep those fried food products at a heated temperature set by the user. These fried food products are typically associated to be in the form of various meats, breads, vegetables and the like that are prepared by the user in a manner such as pan frying or deep frying wherein fats and cooking oils are typically found atop of, or absorbed into, the fried food product and those same fats and cooking oils are desired to be removed by the user before consuming generally for the purpose of betterment of the user's health and/or the user's dietary considerations.

### 2. Description of the Related Art

There is already established in the present field of art numerous configurations of apparatuses that have been designed to remove fats and cooking oils from fried food products. As is the present trend, there is a movement by the public to eat healthier and to monitor and limit the amount of fats and cooking oils associated and found within fried foods. Users, being aware of the health benefits associated from maintaining a low-fat diet, are typically loathe to remove fried foods from their diets as they are typically very enjoyable to consume by the user. What users strive for are apparatuses and/or means to remove fats and cooking oils from the fried food products they desire to consume to make those same fried foods better for the user to consume.

One such focus for fat and cooking apparatus involves the utilization of a mechanical apparatus that uses physical force to remove the undesired fats and cooking oils and to displace those same fats and cooking oils into some type of absorption pad. Apparatuses of this sort typically utilize applied pressure, centrifugal force, or other mechanical means to force the fats and cooking oils to be displaced from the fried food to the interior of the apparatus and/or into the absorbent pad. Upon reaching some level wherein the apparatus can no longer absorb any more fats and cooking oils, the apparatus can be disposed of, or the absorption pad can be replaced.

The issues with the apparatuses in the field as they exist currently are that they are difficult to use, difficult to clean, do not thoroughly degrease the fried food, costly to use and/or do not keep the fried food at a temperature level desired by the user. Additionally, the apparatuses tend to be a “one size fits all” approach and are not designed to accommodate fried foods of varying dimensions varying for example as the flatness and curvature of bacon through the depth and breadth of a large piece of meat like a chicken breast or thigh.

What is needed in the art is an apparatus that is capable of being easily used by the consumer, that is easy to clean, efficiently removes undesired fats and cooking oils, inexpensive to use, accommodates fried foods of varying dimensions and keeps the fried food at a desired temperature and can be used outdoors and is portable. The present invention accomplishes all of these goals.

### SUMMARY OF THE INVENTION

The present invention provides an apparatus that is utilizes commonly known parts in the industry, combined with several components that are not well known in the industry, along with a replaceable specialized absorption pad to efficiently remove undesired fats and cooking oils from fried food prior to the fried food being consumed by the user.

One advantage of the present invention is that the invention utilizes a very small “foot print” and saves precious countertop space while achieving the aforementioned benefits. This small “foot print”, combined with incorporated battery power, additionally allows the present invention to be portable and can easily be placed atop a small table top such as found at picnics and campouts.

Additionally, one alternative embodiment of the present invention allows the present invention to be installed on the top of the user's stove or range control panel. This allows the present invention to be readily available right at the point of use and closest to the source of the creation of the fried food. This eliminates both a potential source of dripped fats and cooking oils that would necessitate clean up by the user, but also makes the cooking area safer by eliminating a potential grease fire incurred by dripping fats and cooking oils across a hot burner or open flame.

Yet another advantage of the present invention is that it incorporates specialized absorption pads that accommodates fried foods of varying dimensions. This specialized absorption pad is designed in such a manner to efficiently and effectively remove fats and cooking oils from the fried food. The specialized absorption pad also is easily replaced as it becomes saturated and unusable. Additionally, the specialized absorption pad, as demonstrated, has a simple methodology to manufacture, thus has a low cost to the user to replace

Yet still another advantage of the present invention is that the invention incorporates a vibration unit that is well known in the adult sex toy industry. The vibration unit is utilized to physically oscillate the fried food against the specialized absorption pad to make the pad the most efficient that it can be for removal of fats and cooking oils from the fried food. The advantage of using a vibration unit such as that found in the adult sex toy industry is that the oscillation speed is easily controlled, the power required to operate the vibration unit is very small and can be obtained from a rechargeable source, thus eliminating the need for an external 110-volt AC source. Additionally, the vibration of the fried food helps to force the fats and cooking oils from the interior of the fried food and forces these fats and cooking oils to be expelled from the fried food into the specialized absorption pad.

Yet still another advantage of the present invention is that the invention incorporates a heater unit that is also well-known in computer and hand warmer industry. The heater unit is utilized to provide adjustable heat to the interior of the present invention to keep the fried food at a selected temperature that is desired by the user. Additionally, by keeping the fats and cooking oils at a higher temperature, the flow rate of these particular fluids is increased such that the viscosity is kept lower and the flow rate of these fluids facilitates in easier removal of the same. Additionally, the user desires that the fried food is kept as hot as possible so that the fried food is tastier when consumed. Just like the vibration unit, the heater unit also draws power from a rechargeable battery source charged by USB, thus eliminating the necessity of an external 110-volt AC source. The battery utilized by the heater unit also serves the purpose of allowing the user to pull power from the heater unit to power traditional electronic items like cellphones, lights, etc.

### BRIEF DESCRIPTION OF THE DRAWINGS

The above-mentioned and other features and advantages of the present invention, and the manner of attaining them, will become more apparent and the present invention will be better understood by reference to the following description of embodiments of the present invention taken in conjunction with the accompanying drawings, wherein:

FIG. 1 illustrates an exploded view of the preferred embodiment of the present invention in the “open” position; and

FIG. 2 illustrates an additional detailed top view of the preferred embodiment of the present invention in the “open” position; and

FIG. 3 illustrates a rear view and side view of the preferred embodiment of the present invention in the “closed” position; and

FIG. 4 illustrates detailed views of a component contained in the present invention; and

FIG. 5 illustrates an additional detailed view of the preferred embodiment of the present invention in the “open” position; and

FIG. 6 illustrates a front view of the Spring Assembly; and

FIG. 7 illustrates a top view of the Spring Assembly; and

FIG. 8 illustrates a detailed front view of a component of the Specialized Absorption Pad; and

FIG. 9 illustrates detailed views of the Horizontal Absorption Pad, Specialized Absorption Pad Base, and Specialized Absorption Pad; and

FIG. 10 illustrates a detailed perspective view of the Specialized Absorption Pad; and

FIG. 11 illustrates an additional detailed view of the present invention; and

FIG. 12 illustrates a perspective view of an alternative embodiment of the present invention; and

FIG. 13 illustrates a perspective view of alternative embodiment of the present invention; and

FIG. 14 illustrates a perspective view of the present invention in the “open” position; and

FIG. 15 illustrates a perspective view of the Specialized Absorption Pad and Bottom Absorption Pad.

Corresponding reference characters indicate corresponding parts throughout the several views. The exemplifications set out herein illustrate preferred embodiments of the present invention, and such exemplifications are not to be construed as limiting the scope of the invention in any manner.

### DETAILED DESCRIPTION OF THE PRESENT INVENTION

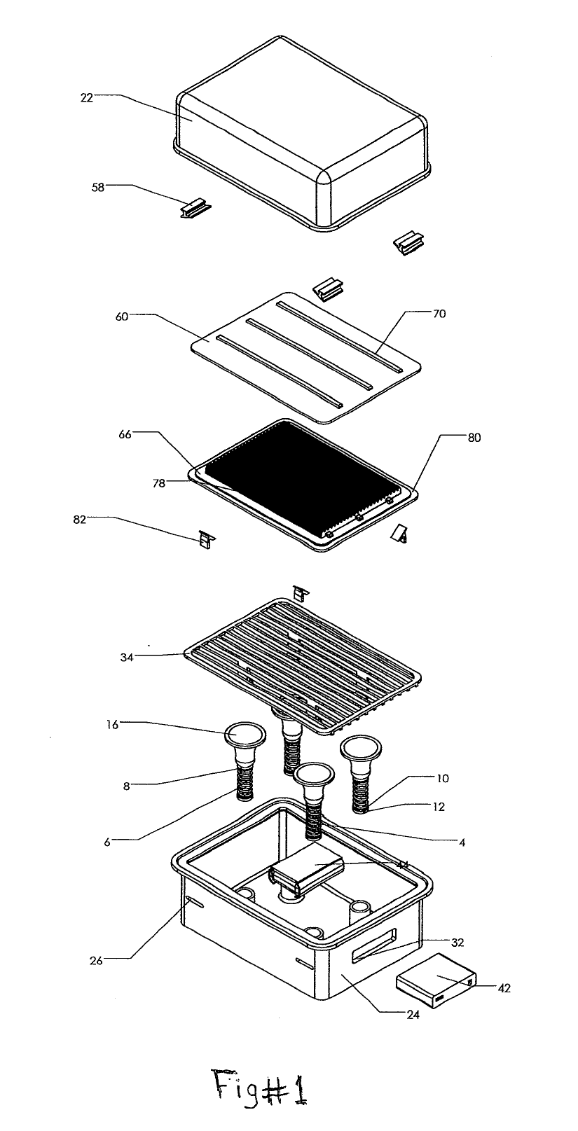

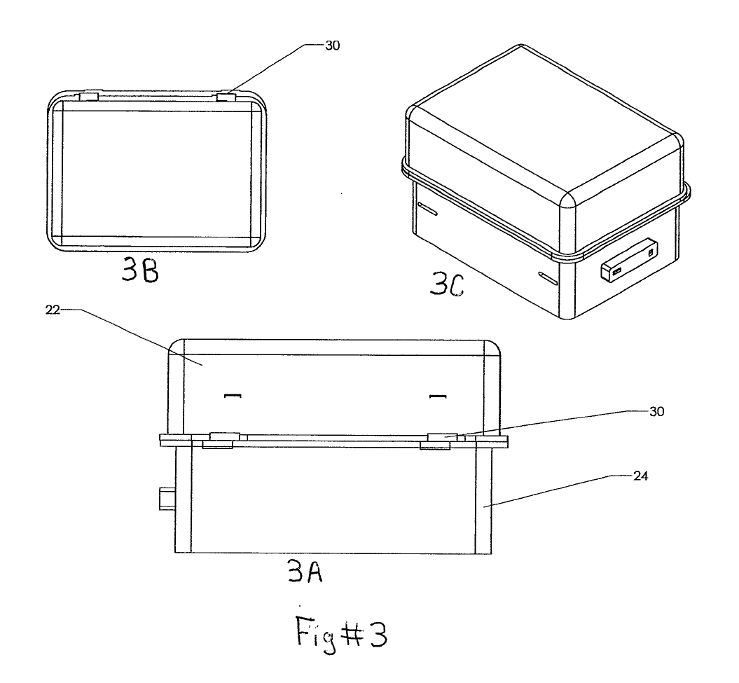

Referring now to the drawings, and, more particularly to FIGS. 1-5 the preferred embodiment of the present invention there is demonstrated an apparatus for food degreasing/warming 2 (the “Apparatus”), said Apparatus 2 comprising a Top Lid 22, a Bottom Lid 24, an at least one Hinge 30 mechanically affixing the Top Lid 22 to the Bottom Lid 24 along the outer longitudinal surface of the Top Lid 22 and the Bottom Lid 24 such that a “clam shell” like configuration between the Top Lid 22 and the Bottom Lid 24 is created. The “clam shell” methodology allows the Top Lid 22 and Bottom Lid 24 to be opened up for the purposes of: inserting/removing food product; replacement of certain absorption pads to be further described in detail; and cleaning of the Apparatus 2; and access to other elements to be further described in detail. The Hinge 30 is commonly known in the industry and is contoured in such a manner to fit the cross-sectional profile of both Top Lid 22 and the Bottom Lid 24 whilst allowing both Top Lid 22 and the Bottom Lid 24 to be opened up to 180 degrees and to lay “flat” when opened.

Now referring to FIGS. 1, 2 and 5, mechanically affixed into the interior of the Top Lid 22 is at least two (2) of a Specialized Absorption Pad Rack Clip 58 equally spaced apart and located at opposite ends of the interior of Top Lid 22 and located in such a position as to be able to mechanically grasp a Specialized Absorption Pad Base 74 at a first end and at a second end of a Specialized Absorption Pad 60.

Still referring to FIGS. 1, 2 and 5, affixed into the interior of the Bottom Lid 24 is an at least one Spring Assembly 4 in such a manner as the longitudinal axis of Spring Assembly 4 runs perpendicular to the interior of the Bottom Lid 24. Each Spring Assembly 4 is utilized to support a Shaker Rack 34 above a Heater Unit 42 and a Vibration Unit 44.

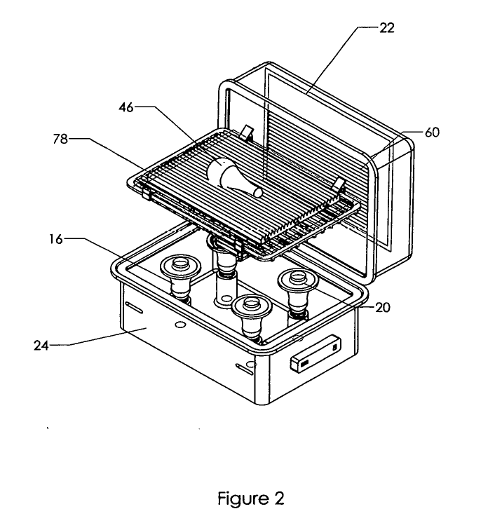

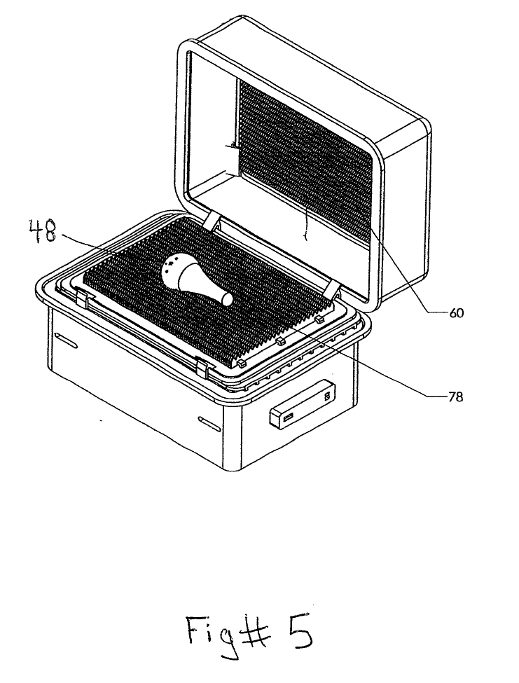

Now referring to FIGS. 2 and 5, mechanically affixed onto the interior surface of the Bottom Lid 24 is the Heater Unit 42. Heater Unit 42 is located on one end of the Bottom Lid 24 traversing through a Heater Hole 32 that is located on the non-hinged surface of the Bottom Lid 24. The Heater Unit 42 is commonly known in the computer and hand warmer industry as a rechargeable heating source that generates a thermostatically-controlled heat setting created by drawing power from a rechargeable battery source contained in the Heater Unit 42. In the preferred embodiment of the present invention, the Heater Unit 42 is that commonly known to be a USB-powered hand-held heater unit used to warm one's hands in cold weather, wherein the Heater Unit 42 contains a means to adjust the output temperature setting at various levels selected by the user. Additionally, the Heater Unit 42 is rechargeable by a USB power source similar to that utilized for a cellular telephone. Additionally, the Heater Unit 42 contains a USB port that can be utilized by the user as a means to charge a cellphone, light and other device that would require USB power. The Heater Unit 42 can hold a charge up to 6 to 8-hours dependent upon the temperature output setting chosen by the user. Additionally, the Heater Unit 42 is well known in the industry to be UL® approved for consumer safety and is fabricated in such a manner as to be water and oil resistant and has been provided additional safeguards and covers to be impervious to water penetration when being cleaned and also impervious to a Fats-Cooking Oil 48 that may drip upon the Heater Unit 42. Additionally, Heater Unit 42 is removable from the Apparatus 2 for recharging.

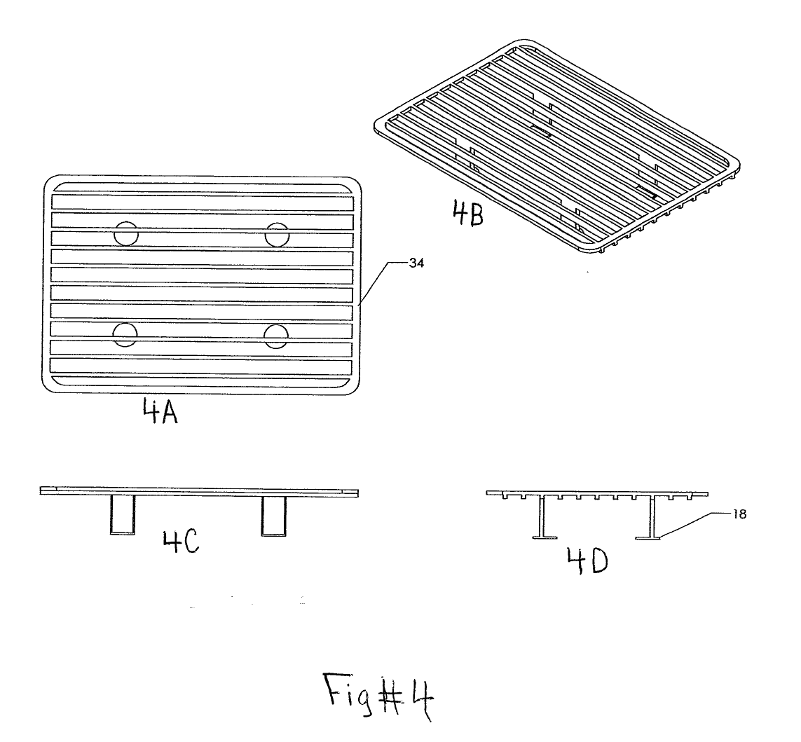

Still referring to FIGS. 1 and 4, the Vibration Unit 44 also has the same characteristics as the Heater Unit 42 in regards to being UL® approved and having additional safeguards and to covers to be impervious to water and Fats-Cooking Oil 48. The Vibration Unit 44 is also mechanically affixed to the interior surface of the Bottom Lid 24, but is generally centrally located on the interior surface of the Bottom Lid 24. The Vibration Unit 44 is mechanically affixed to the Shaker Rack 34. The Vibration Unit 44 is utilized to provide an oscillating motion to the Shaker Rack 34 in a general side-to-side direction that is planer to the interior surface of the Bottom Lid 24 and provides a quick oscillation movement to the Shaker Rack 34. In the preferred embodiment of the present invention, the Vibration Unit 44 is commonly known to be that of a similar configuration found in adult sex toys. In adult sex toys, the apparatus providing the oscillation motion is completely sealed and impervious to various fluid substances, is easily cleanable and can withstand moderate temperatures. Additionally, the amount of oscillation motion is easily adjustable by the user by either mechanical manipulation of either a push or slide button controller that is either wired or wireless, or a means of a twist-like knob. What is preferred for the present invention is a vibration controller that is similar to that which is popular in the adult sex toy industry and is a wireless hand held 5-speed remote control allowing a user to adjust the oscillation frequency without physical manual manipulation of the vibration unit. Additionally, Vibration Unit 44 also is removable from the interior of Bottom Lid 24 for purposes of changing the batteries that power Vibration Unit 44.

Now referring to FIGS. 1,2, 4 and 5, the Shaker Rack 34 rests atop the at least one Spring Assembly 4. In the preferred embodiment of the present invention, each Spring Assembly 4 is placed into a recess that is molded into the bottom surface of the Bottom Lid 24 protruding outwardly and perpendicular to the bottom surface of the Bottom Lid 24. The purposes of these protrusions is to help limit the movement of the Spring Assembly 4 in the interior of Bottom Lid 24 and also prevents the Shaker Rack 34 from swaying too far side-to-side in any particular direction. Additionally, this recess keeps each Spring Assembly affixed into place into the interior of the Bottom Lid 24 and in such a position to be atop of the Heater Unit 42 and the Vibration Unit 44.

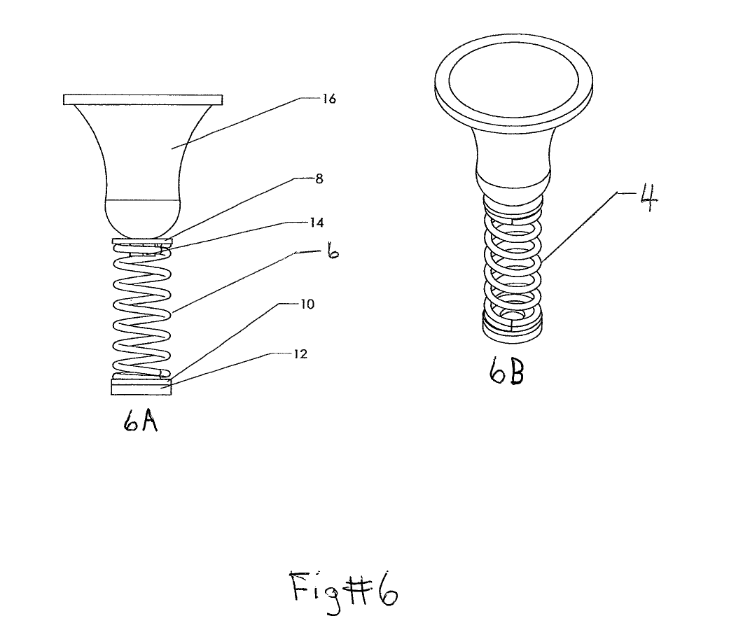

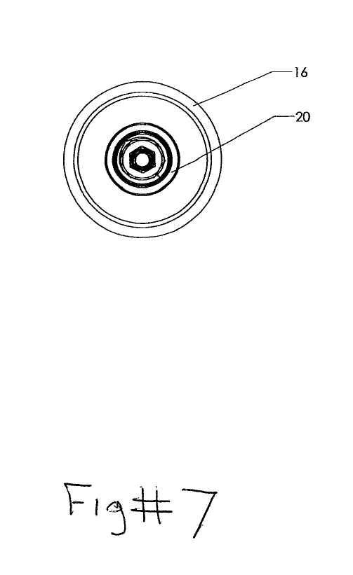

Now referring specifically to FIGS. 5, 6, and 7, each Spring Assembly 4 is comprised of various components including a Spring 6, a Top Washer 8, a Bottom Washer 10, a Bottom Recess Magnet 12, a Bolt Assembly 14, a Shaker Rack Holder 16, and a Magnet 20. The Spring 6 is commonly known in the industry to be that of a compression spring configuration having a first end and a second end. Attached to the first end of Spring 6 is the Top Washer 8 and attached to the second end of Spring 6 is the Bottom Washer 10. Atop the Top Washer 8 is the Shaker Rack Holder 16. A Bolt Assembly 14 mechanically affixes the Magnet 20, the Shaker Rack Holder 16, the Top Washer 8 and the first end of Spring 6 together. The overall general shape of the Shaker Rack Holder 16 is that of a “bell” with the “top” of the “bell” being placed adjacent to the Top Washer 8. The “opening” of the “bell” is placed opposite of the Top Washer 8. Placed on the interior of the Shaker Rack Holder 16 into the “opening” of the “bell” is the Magnet 20. In the preferred embodiment of the present invention, the Spring 6, the Top Washer 8, the Shaker Rack Holder 16 and the Magnet 20 are mechanically affixed along the longitudinal axis of the Spring 6 utilizing commonly known machine bolt and nut configurations. On the second end of the Spring 6 is the Bottom Washer 10 and the Bottom Recess Magnet 12. Located on approximately each corner of the Shaker Rack Holder 16 is a Shaker Rack Foot 18. The purpose of the Magnet 20 in each Spring Assembly 4 is to affix the Shaker Rack 34 via magnetic force applied to each Shaker Rack Foot 18 as each Shaker Rack Foot 18 protrudes away from the Shaker Rack 34 bent into the wire racking of Shaker Rack 34 that match the “bell” shape of the Shaker Rack Holder 16. The protrusion of each Shaker Rack Foot 18 is towards and perpendicular the bottom surface of the Bottom Lid 24. This allows the Shaker Rack 34, while a Fried Food 46 is placed atop it and a Bottom Absorption Pad 78, to remain in place atop each Spring Assembly 4 while Vibration Unit 44 is oscillating the Shaker Rack 34, and corresponding Bottom Absorption Pad 78 and the Fried Food 46, to remove the Fats Cooking Oil 48. Additionally, by utilizing magnetic force, the user of Apparatus 2 can easily remove Shaker Rack 34 from the interior of Apparatus 2 just by physically pulling on Shaker Rack 34 up and away from the interior of Bottom Lid 24.

Now referring to FIGS. 1,2, and 11, the interaction and relationship between Shaker Rack 34, Bottom Absorption Pad 78, a Bottom Absorption Pad Base 80, a Bottom Absorption Pad Clip 82, Fried Food 46, and Specialized Absorption Pad Clip 58, Specialized Absorption Pad 60, and the Specialized Absorption Pad Base 74 is best demonstrated. As these Figures depict, the Bottom Absorption Pad 78 is affixed to the Bottom Absorption Pad Base 80. Likewise, Specialized Absorption Pad 60 is affixed to Specialized Absorption Pad Base 74. For the Bottom Absorption Pad Base 80, it is larger in its overall dimension than Bottom Absorption Pad 78 and is clipped into each Bottom Absorption Pad Clip 82. This allows both the Bottom Absorption Pad 78 and Bottom Absorption Pad Base 80 to be easily removed and disposed of by the user when saturated with the Fats Cooking Oil 48 from the Fried Food 46. Similarly, Specialized Absorption Pad Base 74 is also larger than the Specialized Absorption Pad 60 and is clipped into each Specialized Absorption Pad Clip 58. This too allows the user to remove the Specialized Absorption Pad 60 when saturated with the Fats-Cooking Oils 48 from Fried Food 46.

In the preferred embodiment of the present invention, the Specialized Absorption Pad Base 74 ends are folded over onto itself approximately ½″ creating a Specialized Absorption Pad Lip 76. Specialized Absorption Pad Lip 76 is then inserted into each of the Specialized Absorption Pad Clip 58. Specialized Absorption Pad Lip 76 aids in keeping Specialized Absorption Pad 60 in place as it gets saturated with Fats Cooking Oil 48. The fold used to create Specialized Absorption Pad Lip 76 also provides additional benefit as it strengthens Specialized Absorption Pad Base 74 as will be explained further.

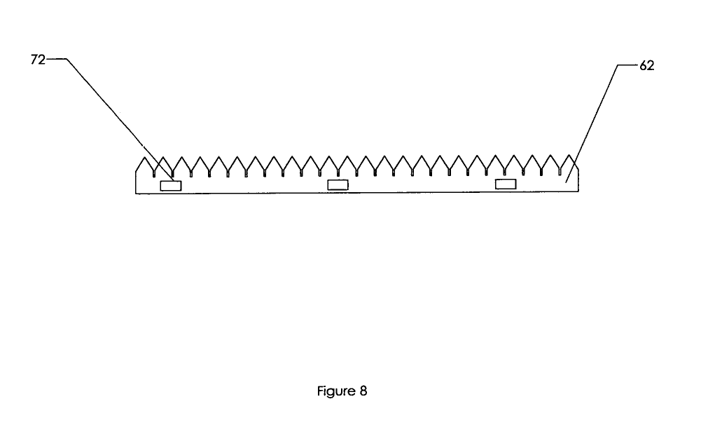

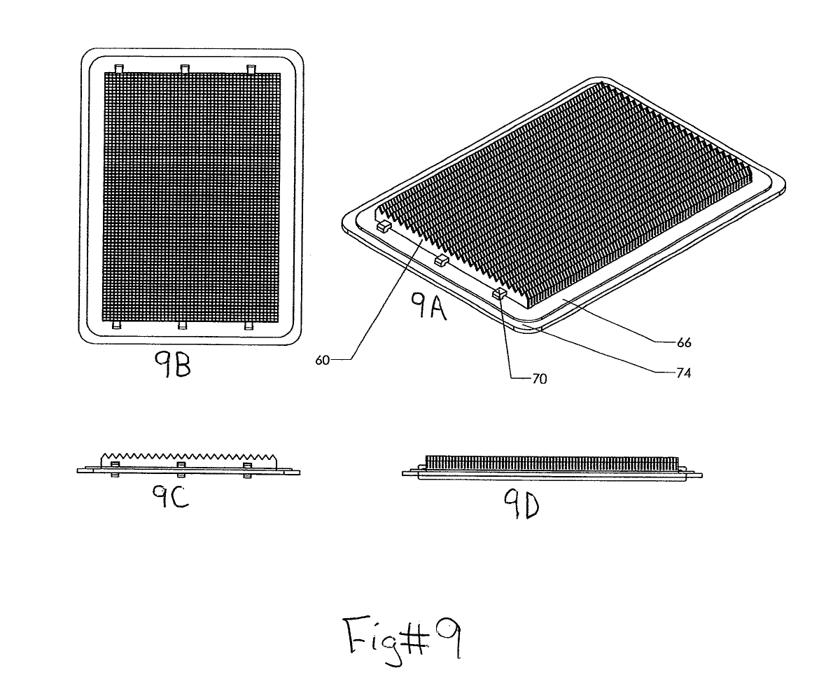

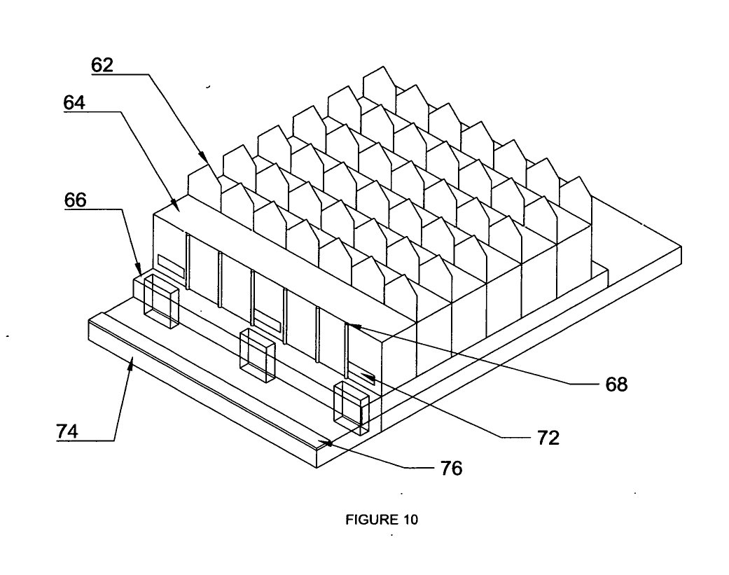

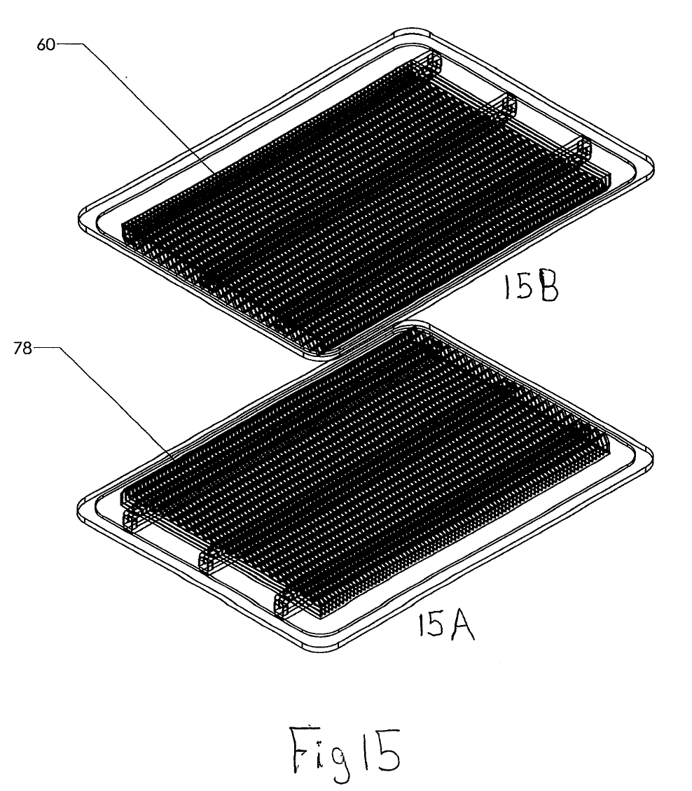

Now referring to FIGS. 8-11, and 15 there is demonstrated the Specialized Absorption Pad 60, which is really the key component of Apparatus 2. The Specialized Absorption Pad 60 comprises various components including a compilation of a Vertical Fringed Absorption Pad 62, a Vertical Absorption Pad 64, a Horizontal Absorption Pad 66, a plurality of a Spacer Straw 68, an at least one Tie Wrap 70, an at least one Tie Wrap Hole 72, and the Specialized Absorption Pad Base 74.

Looking now at the Vertical Fringed Absorption Pad 62, there is found a first end and a second end with slit cuts starting at the first end of the Vertical Fringed Absorption Pad 62 and traversing perpendicularly way from said first end and the slit terminating at a point away from the second end of the Vertical Fringed Absorption Pad 62. In the preferred embodiment, each first end that has been created by the slitting, is then further cut to create a triangle tip at this end similar to an “arrow” type configuration. Additionally, in the preferred embodiment, the Vertical Fringed Absorption Pad 62 material is that commonly known as “two-ply” paper product and is roughly the thickness of a paper towel with a distance between the first end and second end of each fringe to be that of ½″ and also having a plurality of fringes and an overall width of 9″ overall the fringes. The Vertical Fringed Absorption Pad 62, but could be that of any absorbent product of varying thickness, width and varying distances. The overall effect of the slits is to create a “fringing” effect and “fingers” of absorbent material that make contact with the Fried Food 46 while the present invention is being utilized. It is important to note that the overall distance between the first end and second end of the Vertical Fringed Absorption Pad 62 can be varied to accommodate a variety of Fried Food 46 products and would be different lengths for a Fried Food 46 such as bacon, which is typically fairly flat in shape and something more substantial like a chicken breast or thigh. Additionally, near the second end of the Vertical Fringed Absorption Pad 62 there is at least one of the Tie Wrap Hole 72. Tie Wrap Hole 72 is punched through the second end of the Vertical Fringed Absorption Pad 62 and provides a passage way for the Tie Wrap 70 to traverse through. The purpose of this feature will be explained in more detail later.

Now looking at the Vertical Absorption Pad 64, the overall basis design is fairly simple and also comprises a first end and a second end. In the preferred embodiment, the thickness of the Vertical Absorption Pad 64 is ⅛″ and the distance between the first end and the second end is ¼″, and the overall length is 9″ and is made from a paper absorbent product, but it could be any thickness, length and made of any absorbent material and the aforementioned distance could be varied to accommodate different dimensions of Fried Food 46. Additionally, near the second end of the Vertical Absorption Pad 64 there is at least one of the Tie Wrap Hole 72. Tie Wrap Hole 72 is punched through the second end of the Vertical Absorption Pad 64 and provides a passage way for the Tie Wrap 70 to traverse through. This Tie Wrap Hole 72 is in the same location as the Tie Wrap Hole 72 found in the Vertical Fringed Absorption Pad 62. This is done so that Tie Wrap 70 can be installed through both the Vertical Fringed Absorption Pad 62 and Vertical Absorption Pad 64. Once assembled, Vertical Absorption Pad 64 is placed adjacent and parallel to the Vertical Fringed Absorption Pad 62 to make a “layered” absorbent pad similar to that of a 2-ply paper towel or a stack of cheese slices.

Found directly adjacent to the Vertical Absorption Pad 64 as a plurality of Spacer Straw 68 having a first end and a second end and essentially when combined with the Vertical Fringed Absorption Pad 62 and Vertical Absorption Pad 64 creates a “3-ply” type layer. The longitudinal axis of the Spacer Straw 68 runs parallel with longitudinal axis generated by the first end and second end of the Vertical Absorption Pad 64, which is also parallel with the longitudinal axis generated by the first end and second end of the Vertical Fringed Absorption Pad 62. The plurality Spacer Straw 68 are equally spaced along the face of the Vertical Absorption Pad 64 and have the same distance associated between the first end and second end as the Vertical Absorption Pad 64. The purpose of the Spacer Straw 68 is that it helps to siphon, or wick away, Fats Cooking Oil 48 from the surface of Fried Food 46, when the Fried Food 46 is placed upon the Bottom Absorption Pad 78 and the Specialized Absorption Pad 60 makes contact with Fried Food 46 when Top Lid 22 is closed by the user. Additionally, Spacer Straw 68 prevents over compression of the Vertical Fringed Absorption Pad 62, Vertical Absorption Pad 64 layers when the plurality of Tie Wrap 70 are inserted through the plurality of Tie Wrap Hole 72 and tightened. Over compression of these absorption pads would negatively affect the efficacy of Specialized Absorption Pad 60 in removing Fats Cooking Oil 48 from Fried Food 46. All Fats Cooking Oil 48 that is siphoned, or wicked away, flows through the interior of the Spacer Straw 68 from the first end of Spacer Straw 68 to the second end of Spacer Straw 68 and exits the Spacer Straw 68 second end into the Horizontal Absorption Pad 66. The overall diameter of Spacer Straw 68 can be varied to accommodate varying sizes of Apparatus 2 that would vary due to the invention being used in a residential or commercial setting and also to accommodate varying sizes of Fried Food 46. In the preferred embodiment, the Spacer Straw 68 is ¼″ tall and are spaced ½″ apart and are a similar diameter to that known to be a “coffee stirrer.”

Once the three components are assembled: the Vertical Fringed Absorption Pad 62, the Vertical Absorption Pad 64 and Spacer Straw 68, in the manner as prescribed, which is parallel layering, the process is repeated until the overall desired dimensions of the Specialized Absorption Pad 60 can be obtained. In the preferred embodiment, the overall dimension of the Specialized Absorption Pad 60 would be 8″ wide and 9″ in length and would ½″ tall.

This sub-assembly is then placed atop the Horizontal Absorption Pad 66 in such a manner that the “fringed” fingers of the Vertical Fringed Absorption Pad 62 are perpendicular to the surface of the Horizontal Absorption Pad 66. The Horizontal Absorption Pad 66 also contains a plurality of the Tie Wrap Hole 72 and are laid out in the same dimensions as those found in the Vertical Fringed Absorption Pad 62 and Vertical Absorption Pad 64. The Horizontal Absorption Pad 66 is placed atop the Specialized Absorption Pad Base 74 that also has a plurality of Tie Wrap Hole 72. The purpose of all Tie Wrap Hole 72 is so that the Tie Wrap 70 can be traversed through these holes and mechanically affix the aforementioned sub-assembly to the Horizontal Absorption Pad 66 to the Specialized Absorption Pad Base 74. In the preferred embodiment, there is found three (3) such Tie Wrap Hole 72. The purpose of the Horizontal Absorption Pad 68 is to absorb Fats Cooking Oil 48 that would be siphoned, or wicked through, Spacer Straw 68, and/or absorbed by the Vertical Fringed Absorption Pad 62 and the Vertical Absorption Pad 64. All three of the aforementioned absorption pads are developed from materials that have different absorption rates. In the preferred embodiment, the overall dimensions of this item is 9″ by 8″ by ½″ thick.

These four components are then affixed to the Specialized Absorption Pad Base 74. This pad also has the same Tie Wrap Hole 72 as found and described in the previous items and serves the same purpose: securing the four components via the Tie Wrap 70. In the preferred embodiment, this item is manufactured from cardboard and would be 8″ by 11″.

As previously described, Specialized Absorption Pad Base 74 has one Specialized Absorption Pad Lip 76 on each end created by folding over each end of the Specialized Absorption Pad Base 74 atop itself approximately ½″. One additional benefit from this feature is it increases the thickness of Specialized Absorption Pad Base 74 in the area where each Tie Wrap Hole 72 is disposed through. This “doubling” of material creates a stronger and reinforced area for the Tie Wrap 70 to traverse through as it is tightened to hold all of the aforementioned components of the Specialized Absorption Pad 60 together. The overall design and technology for both the Bottom Absorption Pad 78 and the Specialized Absorption Pad 60 are the same.

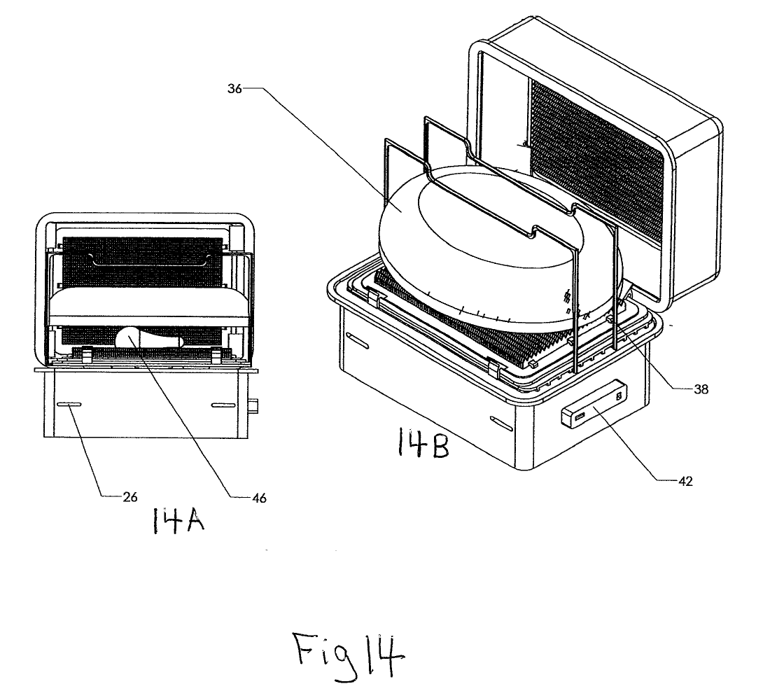

Now referring to FIG. 14, the Apparatus 2 is demonstrated with Fried Food 46 placed into the interior of Apparatus 2 with the Top Lid 22 being in the “open” configuration ready to be rotated to the “closed” position atop Fried Food 46. As demonstrated in this Figure, the major components of Apparatus 2 are shown in their relative positions, which are the Top Lid 22, Bottom Lid 24, Heater Unit 42, Vibration Unit 44, Shaker Rack 34, Specialized Absorption Pad 60, Specialized Absorption Pad Clip 58, Bottom Absorption Pad 78, Bottom Absorption Pad Clip 82, Spring Assembly 4 and Shaker Rack Serving Basket 36 and Shaker Rack Serving Basket Attachment Arm 38.

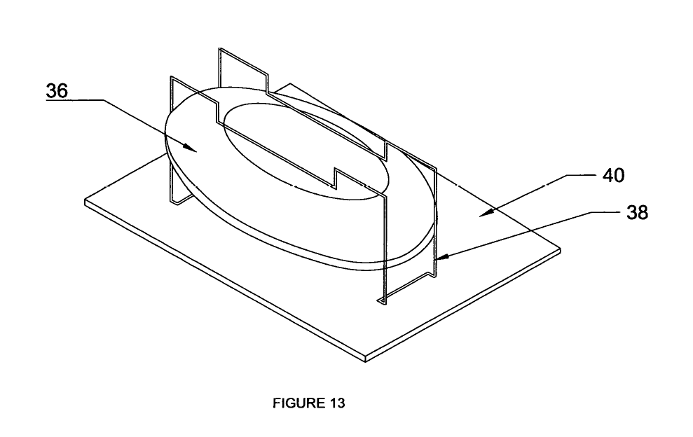

Now referring to FIG. 13, there is demonstrated an alternative embodiment of the present invention in that a Shaker Rack Serving Basket 36 having a first end and a second end is shown with an optional Serving Mat 40. The Shaker Rack Serving Basket 36 first end and second end have formed into each end a Shaker Rack Serving Basket Attachment Arm 38. Each Shaker Rack Serving Basket Attachment Arm 38 is configured such that is forms a means to engage the first end and second end of the Shaker Rack 34 by forming a ledge to traverse under the first end and second end of Shaker Rack 34. The purpose of Shaker Rack Serving Basket 36 and Serving Mat 40 is to allow the user of Apparatus 2 to engage Shaker Rack 34 with Fried Food 46 placed atop it and Bottom Absorption Pad 78. This allows the user to remove Shaker Rack 34 from Shaker Rack Holder 16 and Fried Food 46 when engaged by Shaker Rack Serving Basket 36 and turn Shaker Rack 34 upside down depositing Fried Food 46 either directly into Shaker Rack Serving Basket 36 or atop Serving Mat 40 that has been placed into the interior of Shaker Rack Serving Basket 36. Due to the prior configuration of Shaker Rack 34 and Bottom Absorption Pad 78 as previously described, once Fried Food 46 is transferred into the interior of Shaker Rack Serving Basket 36, Shaker Rack 34 can then be deposited back into the interior of Apparatus 2 and be ready to accept additional Fried Food 46 by the user.

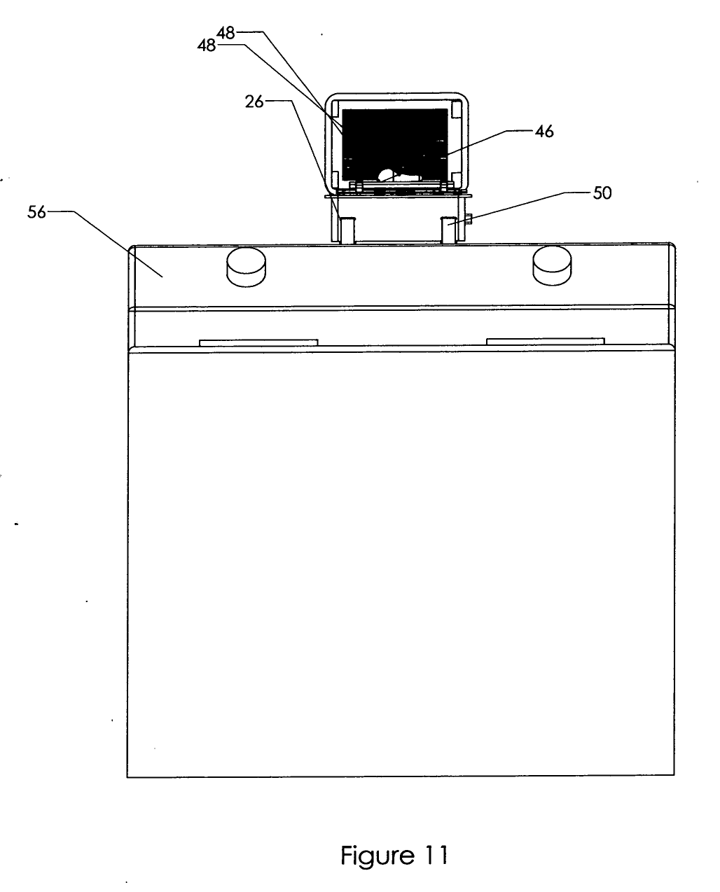

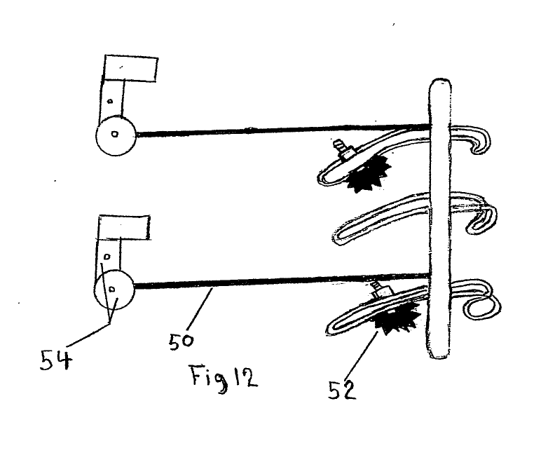

Now referring to FIGS. 11-14, there is a demonstrated an alternative embodiment of the present invention in that a Range Rack Holder 50 is formulated with a means to mechanically affix Apparatus 2 to a Range 56. Traditionally, a user of Apparatus 2 would prefer Apparatus 2 to be at the “point of use”, meaning that it would be ideal to have the Apparatus 2 to be located as close as possible to the source of the Fried Food 46 and the Fats Cooking Oil 48. Utilizing the Range Rack Holder 50 and installing the same on the control panel, or “back” of the Range 56, allows the Apparatus 2 to be located directly adjacent to the burners used to cook the Fried Food 46. Additionally, having the Apparatus 2 located in the immediate vicinity of the source of the Fried Food 46, limits the distance that the Fried Food 46 has to travel from the cooking source to the Apparatus 2, which limits the amount of the Fats Cooking Oil 48 that would be deposited onto the top of the Range 56.

The Range Rack Holder 50 has a first end and a second end with the first end being used to hold the Bottom Lid 24 via metal “fingers” formed in the frame of the Range Rack Holder 50. These “fingers” traverse into Bottom Lid 24 through a Bottom Lid Range Rack Holes 26. Bottom Lid Range Rack Holes 26 are located on the longitudinal surface of Bottom Lid 24 that is directly across from the longitudinal surface wherein the Hinge 30 is attached to. Each Bottom Lid Range Rack Hole 26 has placed into it a Bottom Lid Range Rack Hole Rubber Gasket 28. The purpose of Bottom Lid Range Rack Hole Rubber Gasket 28 is to seal the opening created by each Bottom Lid Range Rack Hole 26 and to form a tight seal when each “finger” of each Range Rack Holder 50 is inserted into each Bottom Lid Range Rack Hole 26.

Attached to each “arm” of Range Rack Holder 50, there is mechanically affixed a Range Rack Insulator Pad 54 directly placed under each “finger” of the first end of the Range Rack Holder 50. The purpose of each Range Rack Insulator Pad 54 is to provide a means of absorbing vibrations created by the operation of Apparatus 2 by the user. Each Range Rack Insulator Pad 54, in combination with each Bottom Lid Range Rack Rubber Gasket 28, helps to dampen vibrations and makes it so vibrations are transferred to Range 56.

Attached to the second end of Range Rack Holder 50 is an at least one Range Rack Holder Adjustment Knob 52. Each Range Rack Holder Adjustment Knob 52 provides a mechanical means to make Range Rack Holder 50 adjustable to fit a wide range of Range 56 control panel thicknesses. The user can turn Range Rack Holder Adjustment Knob 52 either “in” or “out” to accommodate Range 56.

While this invention has been described with respect to preferred embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains, and to which the claims are directed. It is therefore intended that the present invention be not limited to the exact forms described and illustrated herein, but should be construed to cover all modifications that may fall within the scope of the appended claims.

What I claim is:

1. An apparatus for food degreasing/warming comprising: a top lid; a bottom lid; a specialized absorbent pad; a shaker rack; a vibrator unit; and a heater unit.

2. The device of claim 1 wherein said top lid and said bottom lid are attached by an at least one hinge to the exterior of said top lid and said bottom lid.

3. The device of claim 1 wherein located and attached in the interior of said top lid is the said specialized absorbent pad attached to the interior of said top lid utilizing a mechanical attachment means.

4. The device of claim 1 wherein said specialized absorption pad further comprises an at least one compilation of a vertical fringed absorption pad comprising a first end and a second end, layered directly adjacent to a vertical absorption pad comprising a first end and a second end, layered directly adjacent to an array of equally spaced spacer straw containing a first end and a second end with a longitudinal axis running between said first end and said second end, running perpendicular to said specialized absorbent pad.

5. The device of claim 4 wherein said vertical fringed absorption pad comprises a slit traversing from said first end and terminating prior to said second end and said first end further comprising a tapered point.

6. The device of claim 5 wherein said specialized absorption pad comprises an at least one tie wrap hole traversing through said second end of said plurality of the vertical fringed absorption pads and the second end of said plurality of a vertical absorption pads.

7. The device of claim 1 wherein said specialized absorption pad is affixed to the top surface of a horizontal absorption pad comprising a first end and a second end with said first end and said second end containing at least one tie wrap hole.

8. The device of claim 6 wherein a tie wrap is disposed through said tie wrap hole and affixes together the second end of said vertical fringed absorption pad, the second end of said vertical absorption pad, the spacer straw, and the horizontal absorption pad.

9. The device of claim 7 where in the said vertical fringed absorption pad, the vertical absorption pad, the spacer straw, and the horizontal absorption pad are attached to a specialized absorption pad base having a first end and a second end.

10. The device of claim 8 wherein said first end and said second end of said specialized absorption pad base is attached to said specialized absorption pad clip by a mechanical anchor means.

11. The device of claim 1 wherein located and attached in the interior of said bottom lid is a shaker rack attached to the interior of said bottom lid utilizing an at least one spring assembly, having a first end and a second end wherein said first end is attached to said shaker rack by magnetic adhesion and said second end is attached to said interior of said bottom lid by magnetic adhesion.

12. The device of claim 1 wherein a bottom absorption pad base having a first end and a second end wherein said first end and said second end are attached to said shaker rack by a mechanical anchor means.

13. The device of claim 11, wherein attached to said bottom absorption pad base is a bottom absorption pad.

14. The device of claim 1 wherein attached to said interior of said bottom lid and said shaker rack is a vibrator unit means that provides oscillating movement to said shaker rack.

15. The device of claim 1 wherein attached to said interior of said bottom lid is a heater unit means that provides an adjustable heat source to the interior of said bottom lid and interior of said top lid.

16. An apparatus for removing fats and cooking oils from fried foods, the apparatus containing a top lid, a bottom lid, a lower rack, a plurality of absorbent pads, a vibrator unit and a heater unit.

17. The device of claim 16 wherein said top lid and said bottom lid are mechanically attached together with a means to open and allow entry of a fried food into the interior of said device.

18. The device of claim 16 wherein said top lid and said lower rack have provided into the interior of said top lid and said lower rack an at least one absorbent pad.

19. The device of claim 16 wherein said vibrator unit oscillates said lower rack and said fried food contacts said absorbent pad located atop said lower rack and contacts said absorbent pad located atop said upper rack.

20. The device of claim 16 where said heater unit provides an adjustable heat source to said interior of said upper lid and said bottom lid.
